(19) United States
(12) Patent Application Publication
(10) Pub. No.: US 2013/0334277 A1
(43) Pub. Date: Dec. 19, 2013

(54) ELECTRIC TOOL AND METHOD OF DRIVING ELECTRIC TOOL

(71) Applicants: Yukihiro Shima, Ibaraki (JP); Kazuhiko Funabashi, Ibaraki (JP)

(72) Inventors: Yukihiro Shima, Ibaraki (JP); Kazuhiko Funabashi, Ibaraki (JP)

(73) Assignee: HITACHI KOKI CO., LTD., Tokyo (JP)

(21) Appl. No.: 14/001,801

(22) PCT Filed: Feb. 28, 2012
(86) PCT No.: PCT/JP2012/055504

§ 371 Date: Aug. 27, 2013

(30) Foreign Application Priority Data
Feb. 28, 2011 (JP) 2011-042292
Feb. 28, 2011 (JP) 2011-042421

(51) Int. Cl. B25C 1/06; H02P 25/02

(52) U.S. Cl. CPC B25C 1/06; H02P 25/027
USPC 227/131; 318/114

(57) ABSTRACT

When a work stops without driving after a voltage across a capacitor circuit reaches a target boost voltage, a micro-computer switches an FET through a driver circuit. As a result, the voltage charged in the capacitor circuit is charged in a secondary battery through the FET, an inductance, and a parasitic diode of an FET.

### TECHNICAL FIELD

The present invention relates to an electric tool driven by a secondary battery and a method of driving an electric tool, which are suitable for driving the fastener such as a nail or a staple into a material such as wood.

### BACKGROUND ART

A cordless tool having a motor driven by a charged secondary battery has been already put into practical use. An electric double layer capacitor with a relatively high capacitance which can be charged or discharged with a large current has been known. Further, a power nail driver that drives a nail by a solenoid has been known. A variety of systems have been proposed in which a voltage of a battery is applied to a capacitor, and a solenoid is driven by the capacitor having a high output which can discharge a large current to drive a nail. For example, the voltage of the battery is boosted to charge the capacitor, and a voltage across the capacitor is boosted to increase an output of the capacitor. See JP-A-Sho-61-214982, for example.

### SUMMARY

In order to boost the battery of the secondary battery to charge the capacitor, various circuits are required to control the current, and a current consumption of the circuits increases. This leads to such a problem that the consumption of the secondary battery is accelerated, and a work rate per one charging operation is reduced.

Further, in order to step up the battery of the battery to charge the capacitor, various circuits are required to control the current, and a current consumption of the circuits increases. This leads to such a problem that the consumption of the secondary battery is accelerated, and a work rate per one charging operation is reduced. In the case of a primary battery, because a use time is shortened, a plurality of spare primary batteries needs to be provided.

The present invention has been made with recognition of the above status, and an object of the present invention is to provide an electric tool and a method of driving a fastener, which can reduce a current consumption (electric power) of a circuit to improve an efficiency and save an energy so as to suppress a consumption of a second battery in a system where a voltage of the battery is boosted to charge a capacitor.

The present invention has been made with recognize of the above status, and an object of the present invention is to provide an electric tool and a method of driving a fastener, which can reduce a current consumption (electric power) of a circuit to improve an efficiency and save an energy so as to suppress a consumption of a battery in a system where a voltage of the battery is stepped up to charge a capacitor.

According to one aspect of the present invention, there is provided the following arrangements:

(1) An electric tool comprising:

a secondary battery configured to supply an electric power;

a magazine configured to supply a fastener to a driving preparatory position;

a plunger that is projected toward the driving preparatory position so as to strike the fastener existing at the driving preparatory position;

a plunger urging unit configured to urge the plunger in a direction away from the driving preparatory position;

a plunger driving coil configured to generate a magnetic force for supplying a projection force to the plunger for projection to the driving preparatory position; and

a coil voltage generator configured to generate a supply voltage to the plunger driving coil, the coil voltage generator including a booster circuit that boosts a voltage of the electric power supplied from the secondary battery, a capacitor to which an output voltage of the booster circuit is applied, and which is disposed in parallel to the plunger driving coil, and a coil energization switch configured to switch on and off energization from the capacitor to the plunger driving coil,

wherein the secondary battery is configured to be charged by the capacitor having a terminal voltage higher than a terminal voltage of the secondary battery.

(2) The electric tool according to (1) further comprising:

a current control switching element disposed between the capacitor and the secondary battery; and

a controller configured to control the current control switching element,

wherein if the capacitor has the terminal voltage higher than the terminal voltage of the secondary battery, the controller turns on the current control switching element to allow the secondary battery to be charged through the current control switching element from the capacitor.

(3) The electric tool according to (1), wherein

the coil voltage generator includes a controller configured to control the booster circuit,

the booster circuit includes a booster inductance element, a booster switching element and the current control switching element,

the booster inductance element and the booster switching element is connected with each other in series between terminals of the secondary battery,

the capacitor is connected with the booster inductance in series and is connected in parallel to the booster switching element,

a diode parasitic in the current control switching element or disposed in parallel to the current control switching element allows a current to flow in a direction of charging the capacitor, and prevent the current from flowing in an opposite direction, the current flowing between a connection point of the booster inductance element and the booster switching element, and the capacitor, and

the controller is configured to boost the voltage of the electric power supplied from the secondary battery by switching the booster switching element in a state where the current control switching element is off, and is configured to charge the secondary battery through the current control switching element from the capacitor by turning on the current control switching element in a state where the booster switching element is off when the capacitor has the terminal voltage higher than the terminal voltage of the secondary battery.

(4) The electric tool according to (2) or (3), wherein the controller charges the secondary battery after a given time elapses since the terminal voltage of the capacitor reaches a target boost voltage.

(5) The electric tool according to any one of (2) to (4), wherein the controller charges the secondary battery by switching the current control switching element.

(6) The electric tool according to any one of (2) to (5), wherein

the coil voltage generator includes a power switch circuit having a power switching element disposed between the secondary battery and the booster circuit, and

the controller makes the booster circuit inactive and switches the power switching element while the voltage across the capacitor is boosted from an initial voltage to a given voltage equal to or lower than the secondary battery.

(7) The electric tool according to any one of (2) to (6) further comprising a discharge circuit that is disposed in parallel to the capacitor on an output side of the booster circuit,

wherein the discharge circuit includes a discharge resistor and a discharge switching element which are connected in series between both terminals of the capacitor, first and second bias resistors which are connected in series between both the terminals of the capacitor, and a bias control switching element which is disposed in parallel to any one of the first and second bias resistors,

wherein a connection point of the first and second bias resistors is connected to a control terminal of the discharge switching element,

wherein the controller controls a voltage at the control terminal of the bias control switching element,

wherein the discharge switching element is turned off when the bias control switching element is turned on, and

wherein the discharge switching element is turned on when the bias control switching element is turned off.

(8) The electric tool according to (7), wherein

the magazine, the plunger, the plunger urging unit, the plunger driving coil are provided in a main body,

the secondary battery is detachably attached to the main body, and

the bias control switching element turns off when the secondary battery is detached from the main body.

(9) A fastener driving method comprising:

first charging a capacitor so as to reach a target boost voltage by boosting a voltage of a secondary battery;

confirming whether a driving condition in which driving a fastener is possible or a condition in which driving the fastener should be canceled is satisfied;

driving the fastener into a material by using an electric power of the capacitor that has been charged up to the target boost voltage if the driving condition is satisfied; and

second charging the secondary battery from the capacitor that has been charged up to the target boost voltage if the drive stop condition is satisfied.

(10) The fastener driving method according to (9), wherein, in the driving the fastener, a plunger is projected to a driving preparatory position by energizing a plunger driving coil through the capacitor, and the fastener is pushed out by the plunger and driven into the material.

(11) The fastener driving method according to (9) or (10), wherein, in the charging the secondary battery, a current control switching element disposed between the capacitor and the secondary battery is switched.

(12) The fastener driving method according to any one of (9) to (11) further comprising third charging the capacitor from an initial voltage to a given voltage equal to or lower than a voltage of the secondary battery before first charging the capacitor, and

in the third charging the capacitor, a power switching element disposed between the secondary battery and the capacitor is switched.

(13) The fastener driving method according to any one of (9) to (12) further comprising discharging the capacitor by turning on a discharge switching element disposed in parallel to the capacitor when the secondary battery is detached.

(14) An electric tool comprising:

a battery configured to supply an electric power to the main body;

a magazine configured to supply a fastener to a driving preparatory position;

a plunger configured to project toward the driving preparatory position so as to strike the fastener existing at the driving preparatory position;

a plunger urging unit configured to urge the plunger in a direction away from the driving preparatory position;

a plunger driving coil configured to generate a magnetic force for supplying a projection force to the plunger for projection to the driving preparatory position; and

a coil voltage generator configured to generate a supply voltage to the plunger driving coil, the coil voltage generator including a booster circuit that boosts a voltage of the electric power supplied from the battery, a capacitor to which an output voltage of the booster circuit is applied, and which is disposed in parallel to the plunger driving coil, a coil energization switch configured to switch one and off energization from the capacitor to the plunger driving coil, and a controller configured to control the booster circuit, and

wherein the controller is configured to switch a target boost voltage of the booster circuit between a first target voltage and a second target voltage higher than the first target voltage.

(15) The electric tool according to (14) comprising a length detecting unit configured to detect whether a length of the fastener located within the magazine is a given value or longer, or not,

wherein the controller sets the target boost voltage of the booster circuit to the first target voltage when the length detecting unit detects that the length of the fastener is shorter than the given value, and sets the target boost voltage of the booster circuit to the second target voltage when the length detecting unit detects that the length of the fastener is the given value or longer.

(16) The electric tool according to (15), wherein

the length detecting unit includes a light emitting element and a light receiving element which are attached to the magazine, and a light blocking member that extends in a length detection position within a supply path of the fastener in the magazine,

the light blocking member is pushed in a direction out of the supply path by the fastener having the length of the given value or longer which is located at the length detection position, and blocks a light emitted from the light emitting element to the light receiving element, and

the light blocking member does not block the light emitted from the light emitting element to the light receiving element when no fastener having the length of the given value or longer is located at the length detection position.

(17) The electric tool according to (15), wherein

the length detecting unit includes first and second light emitting elements and first ad second light receiving elements which are attached to the magazine, and first and second light blocking members that extend in a length detection position within a supply path of the fastener in the magazine, the first and second light blocking members extending in a direction different from a longitudinal direction of the fastener,

the first light blocking member is pushed in a direction out of the supply path by the fastener having the length of the given value or longer which is located at the length detection position, and blocks a light emitted from the first light emitting element to the first light receiving element,

the first light blocking member does not block the light emitted from the first light emitting element to the first light receiving element when no fastener having the length of the given value or longer is located at the length detection position,

the second light blocking member is pushed in a direction out of the supply path by the fastener which is located at the length detection position, and blocks a light emitted from the second light emitting element to the second light receiving element, and

the second light blocking member does not block the light emitted from the second light emitting element to the second light receiving element when no fastener is located at the length detection position.

(18) The electric tool according to (17), wherein the controller makes the booster circuit inactive when no light reaches any of the first and second light receiving elements from the corresponding first or second light emitting elements.

(19) The electric tool according to any one of (14) to (18), wherein

the coil voltage generator includes a power switch circuit having a power switching element disposed between the battery and the booster circuit, and

the controller makes the booster circuit inactive and switches the power switching element while the voltage across the capacitor is boosted from an initial voltage to a given voltage equal to or lower than the battery.

(20) The electric tool according to any one of (14) to (19), wherein

the booster circuit includes a boosting inductance element, a boosting switching element, and a diode,

the boosting inductance element and the boosting switching element are connected in series between both terminals of the battery,

the capacitor is connected in series with the boosting inductance element, and connected in parallel to the boosting switching element,

the diode allows a current to flow in a direction of charging the capacitor and prevents the current from flowing in an opposite direction, the current flowing between a connection point of the boosting inductance element and the boosting switching element, and the capacitor, and

the controller boosts the voltage of the electric energy supplied from the battery in the booster circuit by switching the boosting switching element.

(21) The electric tool according to any one of (14) to (20) comprising a discharge circuit that is disposed in parallel to the capacitor on an output side of the booster circuit,

wherein the discharge circuit includes a discharge resistor and a discharge switching element which are connected in series between both terminals of the capacitor, first and second bias resistors that are connected in series between both terminals of the capacitor, and a bias control switching element that is disposed in parallel to any one of the first and second bias resistors,

wherein a connection point of the first and second bias resistors is connected to a control terminal of the discharge switching element,

wherein the controller controls a voltage at the control terminal of the bias control switching element, and

wherein the discharge switching element is turned off when the bias control switching element is turned on, and the discharge switching element is turned on when the bias control switching element is turned off.

(22) The electric tool according to (21), wherein

the magazine, the plunger, the plunger urging unit, the plunger driving coil are provided in a main body, and

the battery is detachably attached to the main body, and the bias control switching element turns off when the battery is detached from the main body.

(23) A fastener driving method comprising:

setting a target boost voltage to any one of a first target voltage and a second target voltage higher than the first target voltage;

first charging a capacitor so as to reach the set target boost voltage by boosting a voltage of a battery; and

protruding the plunger to a driving preparatory position by energizing a plunger driving coil by the capacitor charged to the target boost voltage, and driving a fastener into a material by projecting the fastener by the plunger.

(24) The fastener driving method according to (23),

wherein, in the setting, the target boost voltage is set to the first target voltage when the length of the fastener is lower than the given length, and the target boost voltage is set to the second target voltage when the length of the fastener is the given length or longer.

(25) The fastener driving method according to (23) or (24) further comprising second charging the capacitor from an initial voltage to a given voltage equal to or lower than a voltage of the battery before first charging the capacitor,

wherein in the second charging, a power switching element disposed between the battery and the capacitor is switched.

(26) The fastener driving method according to any one of (24) to (25) further comprising discharging the capacitor by turning on a discharge switching element disposed in parallel to the capacitor when the battery is detached.

(27) A electric tool comprising;

a battery configured to supply an electric power; and

a main body including:
a driving unit;
a capacitor configured to accumulate electric charge supplied from the battery; and
a switch configured to switch on and off energization from the capacitor to the driving unit; and
a discharge circuit configured to discharge the electric charge of the capacitor,

wherein the battery is detachably attached to the main body, and

wherein the discharge circuit discharges the electric charge of the capacitor when the battery is detached from the main body.

(28) The electric tool according to (27) further comprising a transforming circuit configured to boost a voltage of the electric power supplied from the secondary battery, the capacitor to which an output voltage of the transforming circuit is applied.

(29) The electric tool according to (27), wherein the driving unit includes a coil for generating a magnetic force.

(30) The electric tool according to (27), wherein

the discharge circuit includes discharge resistor and discharge switching element which are connected in series between both terminals of the capacitor, and

the electric charge of the capacitor is discharged via the discharge resistor and the discharge switching element.

(31) The electric tool according to (30), wherein

the discharge circuit includes first and second bias resistors which are connected in series between both the terminals of the capacitor, and a bias control switching element which is disposed in parallel to any one of the first and second bias resistors,

a connection point of the first and second bias resistors is connected to a control terminal of the discharge switching element,

the discharge switching element is turned off when the bias control switching element is turned on, and

the discharge switching element is turned on when the bias control switching element is turned off.

(32) The electric tool according to (31), wherein

the bias control switching element is turned on when the battery is attached to the main body, and

the bias control switching element is turned off when the battery is detached from the main body.

(33) The electric tool according to (27), wherein

the battery is a secondary battery, and

the electric tool further comprises a switching element electrically connected between the secondary battery and the capacitor in series, and a controller configured to control the switching element,

the controller controls the switching element to charge the secondary battery if the controller detects that the switch is turned off.

(34) The electric tool according to (28) further comprising a controller configured to control the transforming circuit to control charging voltage of the capacitor.

### BRIEF DESCRIPTION OF DRAWINGS

FIG. 1 is a circuit diagram of an electric tool according to an embodiment of the present invention.

FIG. 2 is a timing chart illustrating temporal changes in on/off operation of respective switches in the circuit illustrated in FIG. 1 and a voltage across a capacitor circuit (when a nail is shorter).

FIG. 3 is a timing chart illustrating the same temporal changes (when a nail is longer).

FIG. 4 is a timing chart illustrating the same temporal changes (when a work stops after a voltage has been boosted).

FIG. 5 is a flowchart illustrating the operation of the circuit illustrated in FIG. 1.

FIG. 6 is an external view of the electric tool.

FIG. 7A is a partial cross-sectional view of FIG. 6, and FIGS. 7B and 7C are views taken in a direction indicated by an arrow A of FIG. 7A.

FIGS. 8A to 8C are schematic cross-sectional views for illustrating a length detecting unit in the electric tool in which an interior of a magazine is enlarged.

FIG. 9A is a cross-sectional view taken along a line A-A′ of FIG. 8A, and FIG. 9B is a cross-sectional view taken along a line B-B′ of FIG. 8B.

### DESCRIPTION OF EXEMPLARY EMBODIMENTS

Hereinafter, a preferred embodiment of the present invention will be described in detail with reference to the drawings. The same or equivalent constituent elements, members, and processing illustrated in the respective drawings are denoted by identical symbols, and a repetitive description will be appropriately omitted. The embodiment does not limit the present invention, but exemplify the present invention, and all of the features described in the embodiment, and a combination thereof are not always essential to the present invention.

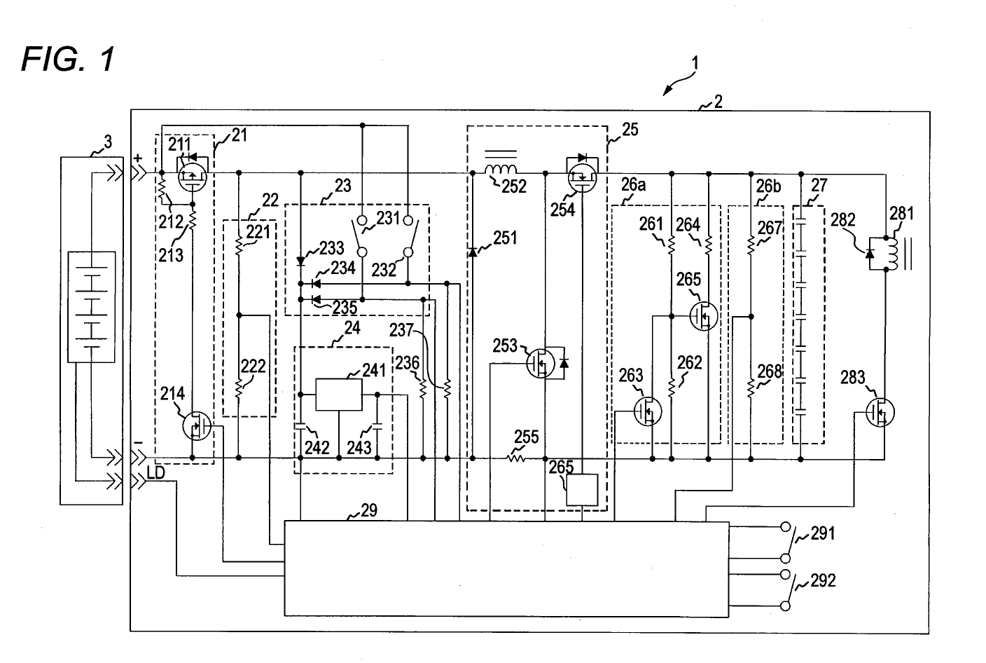

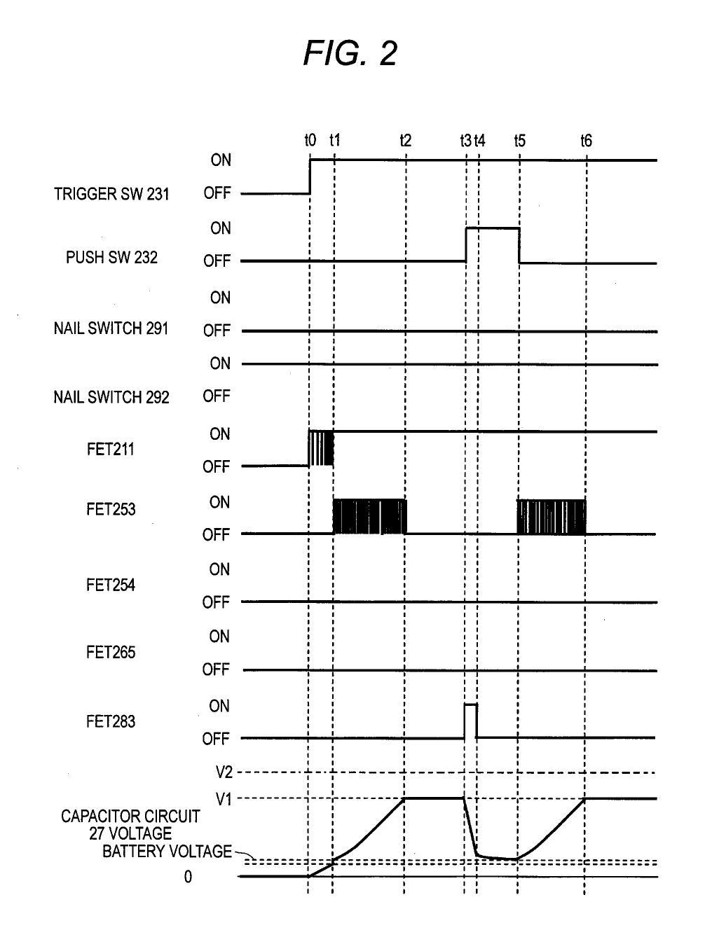

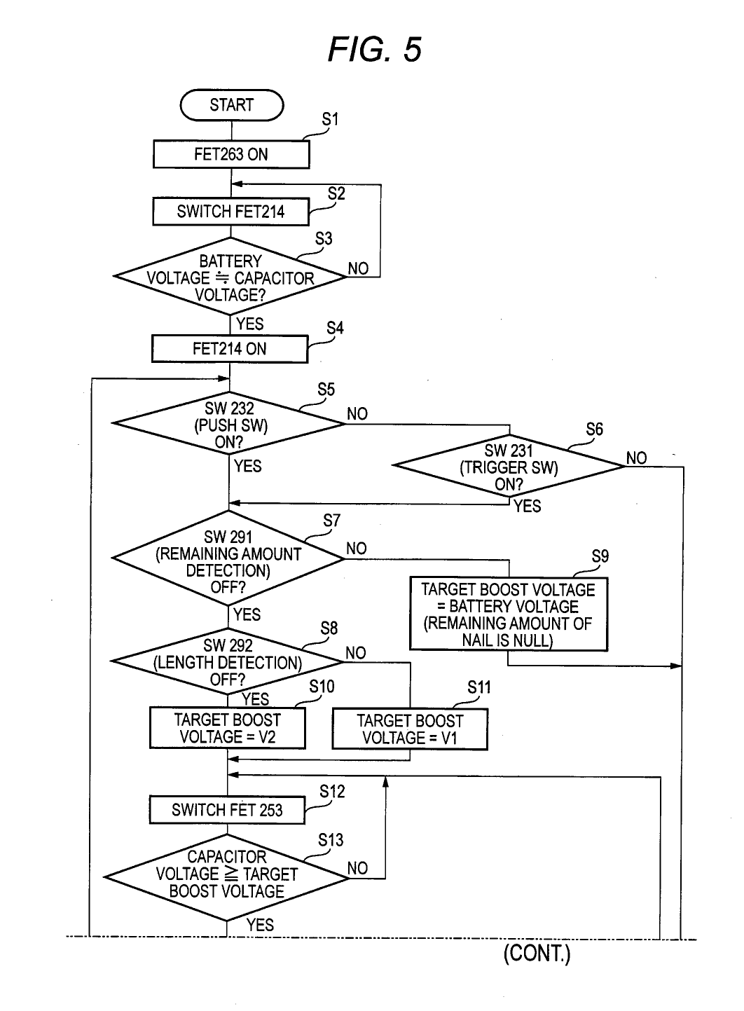

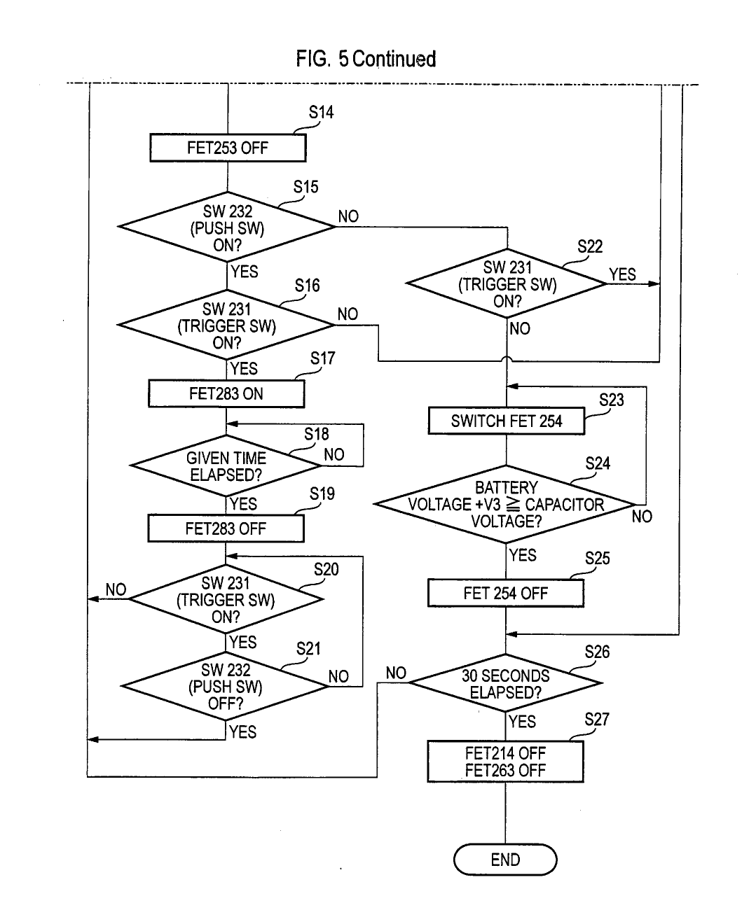

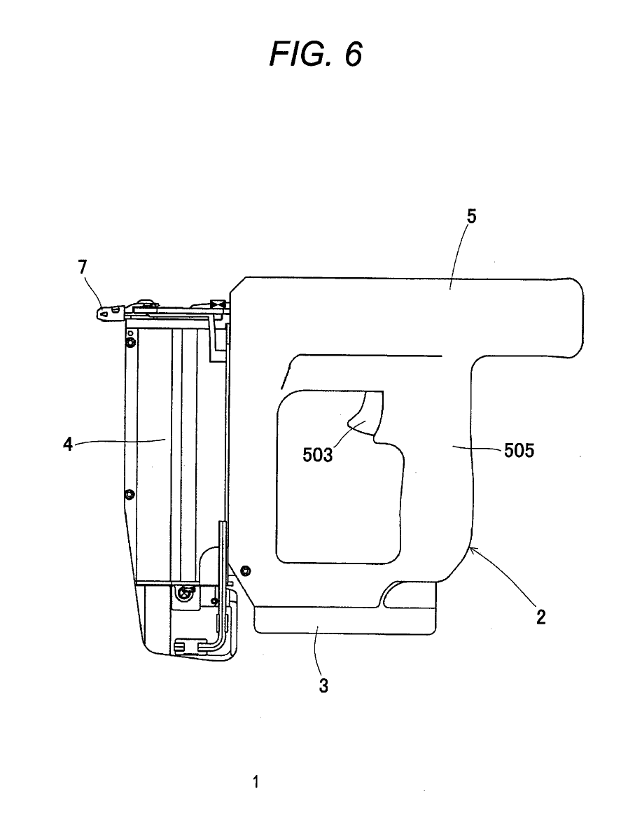

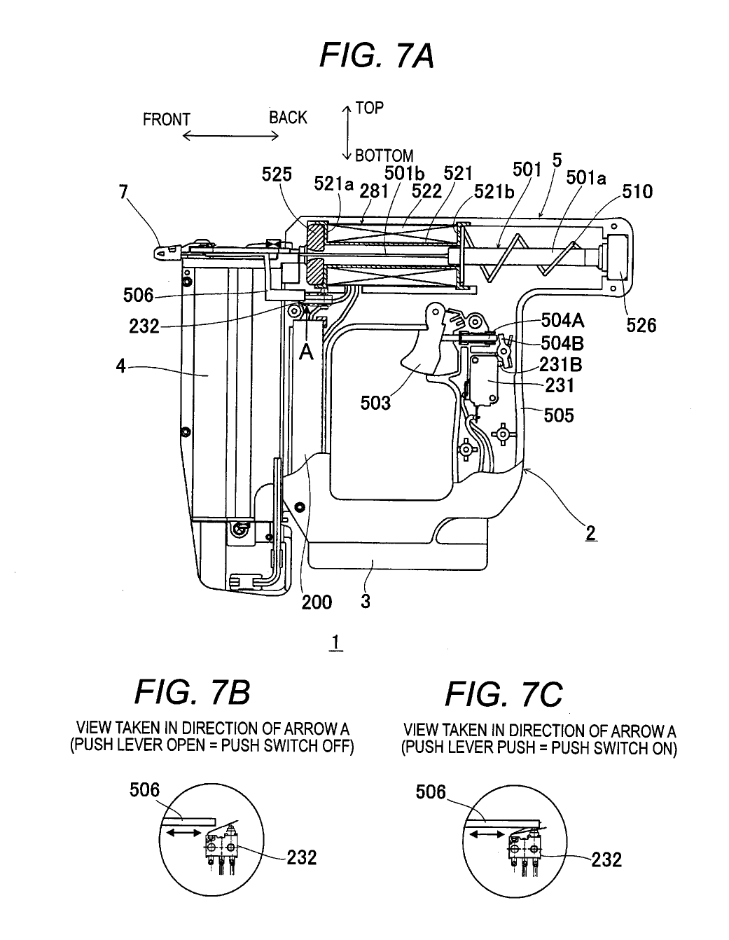

FIG. 1 is a circuit diagram of an electric tool 1 according to an embodiment of the present invention. FIGS. 2 to 4 are timing charts illustrating temporal changes in on/off operation of respective switches in the circuit illustrated in FIG. 1 and a voltage across a capacitor circuit 27. FIG. 5 is a flowchart illustrating the operation of the circuit illustrated in FIG. 1. FIG. 6 is an external view of the electric tool 1. FIG. 7A is a partial cross-sectional view of FIG. 6.

The electric tool 1 according to this embodiment is an electric tool that drives a nail as a fastener into a material such as wood. First, an overall configuration of the electric tool 1 will be described mainly with reference to FIGS. 6 and 7A. An anteroposterior direction and a vertical direction are defined by arrows in FIG. 7A. A nail driving direction is anterior.

The electric tool 1 includes a main body 2, and a secondary battery 3 (for example, lithium ion secondary battery). The secondary battery 3 is detachably attached to a housing 5 of the main body 2, and supplies a power to a circuit (to be described later in FIG. 1) within the main body 2.

The main body 2 includes a plunger 501, a spring 510 as a plunger urging unit, a plunger driving coil 281, a control box 200, a trigger switch 231, and a push switch 232 within the housing 5 made of, for example, resin, and a magazine 4 is attached to a front surface of the housing 5. The control box 200 includes most of the circuit in the main body 2 illustrated in FIG. 1.

The magazine 4 loads a large number of nails in line, and sequentially feeds the nails toward a driving preparatory position. The driving preparatory position is in a space located posterior to a nose part 7 and anterior to the plunger 501 (particularly a leading end blade part 501b). The nose part 7 projects forward from an upper end of the magazine 4, and a leading end of the nose part 7 forms a nail shot port.

A trigger switch 231 which is a mechanical switch such as a micro switch is located (fixed) inside a handle part 505 of the housing 5. When an operator activates a trigger 503 in the figure, a rod 504A slidably supported by the housing 5 is pushed backward by the trigger 503, and an arm 504B rotatably supported by the housing 5 is rotated by the rod 504A. Then, a button 231B is pushed by the arm 504B to turn on a trigger switch 231. That is, the trigger switch 231 is a switch that detects an operator's will. The arm 504B is urged into a state of FIG. 7A, that is, into a state where the button 231B is not pushed, by a torsion spring not shown, and when the operator removes his finger from the trigger 503, the trigger switch 231 turns off.

The push switch 232 that is a mechanical switch such as a micro switch is located (fixed) at a position close to the nose part 7 within the housing 5. When the operator pushes the leading end of the nose part 7 toward a material, a push lever 506 is retreated together with the nose part 7, and the push switch 232 turns on by the push lever 506 (refer to FIGS. 7B and 7C). That is, the push switch 232 is a switch that confirms that the leading end of the nose part 7 forming the nail shot port is pushed toward the material. The push lever 506 is urged forward by a spring not shown, and when the operator detaches the leading end of the nose part 7 from the material, the push switch 232 turns off.

The plunger 501 includes a base end large diameter part 501a and the leading end blade part 501b integrally. The base end large diameter part 501a is, for example, columnar. The leading end blade part 501b is smaller in diameter than the base end large diameter part 501a, and coaxial with the base end large diameter part 501a. The plunger 501 is coaxial with the plunger driving coil 281.

In a non-projected state (state of FIG. 7A) of the plunger 501, the base end large diameter part 501a is located inside the plunger driving coil 281 except for a part of the leading end thereof. A part of the base end large diameter part 501a on a side of the leading end blade part 501b is located inside the plunger driving coil 281, and the remaining part extends toward the rear of the plunger driving coil 281.

The plunger driving coil 281 fixed within the housing 5 is configured by a solenoid having a winding wire 522 wound on a bobbin 521. A ring-shaped forward damper 525 made of an elastic material such as rubber is held by a forward flange part 521a of the bobbin 521 so as to be coaxial with the plunger driving coil 281. An inner diameter of the forward damper 525 is smaller than an outer diameter of the base end large diameter part 501a of the plunger 501, and larger than an outer diameter of the leading end blade part 501b.

The spring 510 is configured by a tension spring, and has one end attached to a backward flange 521b of the bobbin 521, and the other end attached to a base end of the base end large diameter part 501a. The spring 510 urges the plunger 501 backward (toward a direction away from the driving preparatory position). A backward dumper 526 made of an elastic material such as rubber is fixed to the rear of the plunger 501 within the housing 5, and abutted against a base end surface of the base end large diameter part 501a in the non-projected state of the plunger.

A current that flows in the plunger driving coil 281 allows a magnetic force to be generated inside the plunger driving coil 281, and the plunger 501 obtains a projecting force toward the driving preparatory position by that magnetic force. That is, the plunger 501 projects forward (toward the driving preparatory position) against urging of the spring 510 by the aid of the magnetic force generated by the plunger driving coil 281. In this situation, the amount of projection of the plunger 501 is regulated by abutting the leading end surface of the base end large diameter part 501a against the forward damper 525. When the magnetic force of the plunger driving coil 281 is eliminated or weakened, the plunger 501 is returned backward (in a direction away from the driving preparatory position) by the aid of the urging of the spring 510 until the base end surface of the base end large diameter part 501a is abutted against the backward dumper 526.

Hereinafter, a circuit configuration of the electric tool 1 will be described mainly with reference to FIG. 1.

The main body 2 of the electric tool 1 accumulates the electric power from the secondary battery 3 into the capacitor circuit 27, and supplies electric charges thereof to the plunger driving coil 281, thereby driving the plunger 501 illustrated in FIG. 7A to drive the nail. Further, nail detection switches 291 and 292 that detect the length and remaining amount of nails as will be described later are disposed in the magazine 4 that accumulates the nails therein. Control is mainly conducted by a microcomputer (hereinafter referred to as “microcomputer”) 29, and diverse controls are conducted by outputs of the microcomputer 29. Hereinafter, the circuit configuration will be described in detail.

The main body 2 of the electric tool 1 includes, as circuit elements, a power switch circuit 21, a battery voltage detector circuit 22, a switch detector circuit 23, a control power circuit 24, a booster circuit 25, a capacitor discharge circuit 26a, a capacitor voltage detector circuit 26b, the capacitor circuit 27 as the capacitor, the plunger driving coil 281, an FET 283 (n-type MOSFET) as a coil energization switch, and the nail detection switches 291 and 292 that configure a length detecting unit. The circuit elements of the main body 2 illustrated in FIG. 7 except for the plunger driving coil 281 configure a coil voltage generator.

The power switch circuit 21 for controlling energization from the secondary battery 3 includes an FET 211 (p-type MOSFET) as a power switch element, resistors 212 and 213 as bias resistors, and an FET 214 (n-type MOSFET) as a bias control switching element. A source terminal of the FET 211 is connected to a plus terminal of the secondary battery 3. The resistors 212, 213 and the FET 214 are connected in series between the plus terminal and the minus terminal of the secondary battery 3. The resistor 212 is disposed between a gate and a source of the FET 211. The resistor 213 is disposed between a gate terminal (corresponding to a control terminal) of the FET 211 and a drain terminal of the FET 214. A source terminal of the FET 214 is connected to the minus terminal of the secondary battery 3. A gate terminal (corresponding to a control terminal) of the FET 214 is connected to the microcomputer 29.

The battery voltage detector circuit 22 is configured in such a manner that resistors 221 and 222 are connected in series between a drain terminal of the FET 211 and the minus terminal of the secondary battery 3. A connection point of the resistors 221 and 222 is connected to the microcomputer 29.

The switch detector circuit 23 includes the trigger switch 231, the push switch 232, and diodes 233 to 235.

One ends of the trigger switch 231 and the push switch 232 are connected to the plus terminal of the secondary battery 3. The other ends of the trigger switch 231 and the push switch 232 are connected to the control power circuit 24 that will be described later through the diodes 235 and 234, respectively, and connected to the minus terminal of the secondary battery 3 and the microcomputer 29 through resistors 236 and 237, respectively. The diode 233 is disposed between the drain terminal of the FET 211 and the control power circuit 24.

The control power circuit 24 for supplying the electric power to the microcomputer 29 includes a three-terminal regulator 241 as a power circuit, and capacitors 242 and 243. The three-terminal regulator 241 steps down the voltage (for example, 14.4V) of the secondary battery 3, which is input to the three-terminal regulator 241 through the diodes 233 to 235, to an operating voltage (for example, 3.3 V) of the microcomputer 29, and supplies the operating voltage to the microcomputer 29. The capacitors 242 and 243 for stable operation are disposed between an input terminal and an output terminal of the three-terminal regulator 241, and the minus terminal of the secondary battery 3, respectively.

The booster circuit 25 disposed between the drain terminal of the FET 211 and the minus terminal of the secondary battery 3 includes an inductance 252 as a boosting inductance element, an FET 253 (n-type MOSFET) as a boosting switching element, an FET 254 (n-type MOSFET) as a current control switching element, a driver circuit 256, a current detection resistor 255, and a diode 251.

The inductance 252, the FET 253, and the current detection resistor 255 are connected in series through the power switch circuit 21 between the plus terminal and the minus terminal of the secondary battery 3. The drain terminal of the FET 211 is connected with one end of the inductance 252 and a cathode terminal of the diode 251. An anode terminal of the diode 251 is connected to the minus terminal of the secondary battery 3. The other end of the inductance 252 is connected to a drain terminal of the FET 253 and a source terminal of the FET 254. A source terminal of the FET 253 is connected to the minus terminal of the secondary battery 3 through the resistor 255. A gate terminal (corresponding to a control terminal) of the FET 253 is connected to the microcomputer 29. A gate terminal (corresponding to a control terminal) of the FET 254 is connected to the microcomputer 29 through the driver circuit 256. The driver circuit 256 generates a gate voltage (control voltage) for switching the FET 254. The current detection resistor 255 that detects a current is connected to the microcomputer 29, and has a terminal voltage input to the microcomputer 29. Then, a drain terminal of the FET 254 and the source terminal of the FET 253 form a plus output terminal and a minus output terminal of the booster circuit, respectively, and function to charge the capacitor circuit 27 with the electric power of the secondary battery 3.

The capacitor circuit 27 includes a plurality of capacitors (for example, an electric double layer capacitor) connected in series between the output terminals of the booster circuit 25 (the drain terminal of the FET 254 and the source terminal of the FET 253). The capacitor circuit 27 receives the output voltage (boost voltage) of the booster circuit 25, and accumulates (stores) a supply power energy from the booster circuit 25 therein.

A capacitor discharge circuit 26a includes a discharge resistor 264, an FET 265 (n-type MOSFET) as a discharge switching element, resistors 261 and 262 as first and second bias resistors, and an FET 263 (n-type MOSFET) as a bias control switching element.

The resistors 261 and 262 are connected in series between the output terminals of the booster circuit 25 (the drain terminal of the FET 254 and the source terminal of the FET 253). A connection point of the resistors 261 and 262 is connected to a gate terminal (corresponding to a control terminal) of the FET 265 and a drain terminal of the FET 263 (n-type MOSFET). A source terminal of the FET 265 and a source terminal of the FET 263 are connected to the minus output terminal of the booster circuit 25. A gate terminal (corresponding to a control terminal) of the FET 263 is connected to the microcomputer 29. A drain terminal of the FET 265 is connected to the plus output terminal of the booster circuit 25 (the drain terminal of the FET 254) through the discharge resistor 264.

The capacitor voltage detector circuit 26b includes resistors 267 and 268 connected in series between the output terminals of the booster circuit 25 (the drain terminal of the FET 254 and the source terminal of the FET 253). A connection point of the resistors 267 and 268 is connected to the microcomputer 29.

A combined resistance of the resistors 261 and 262 and a combined resistance of the resistors 267 and 268 are set to be larger than the discharge resistor 264. As a result, when no electricity is supplied to the discharge resistor 264, the discharged electric charge of the capacitor circuit 27 is less, and the amount of energy accumulated in the capacitor circuit 27 is maintained.

The plunger driving coil 281 and the FET 283 are connected in series with each other and in parallel to the capacitor circuit 27. A gate terminal (corresponding to a control terminal) of the FET 283 is connected to the microcomputer 29. A diode 282 is connected in parallel to the plunger driving coil 281.

The nail detection switches 291 and 292 connected to the microcomputer 29 are formed of switching elements including photo transistors as light receiving elements of, for example, photo interrupters, and configure a length detecting unit for detecting a length of the nail as described below.

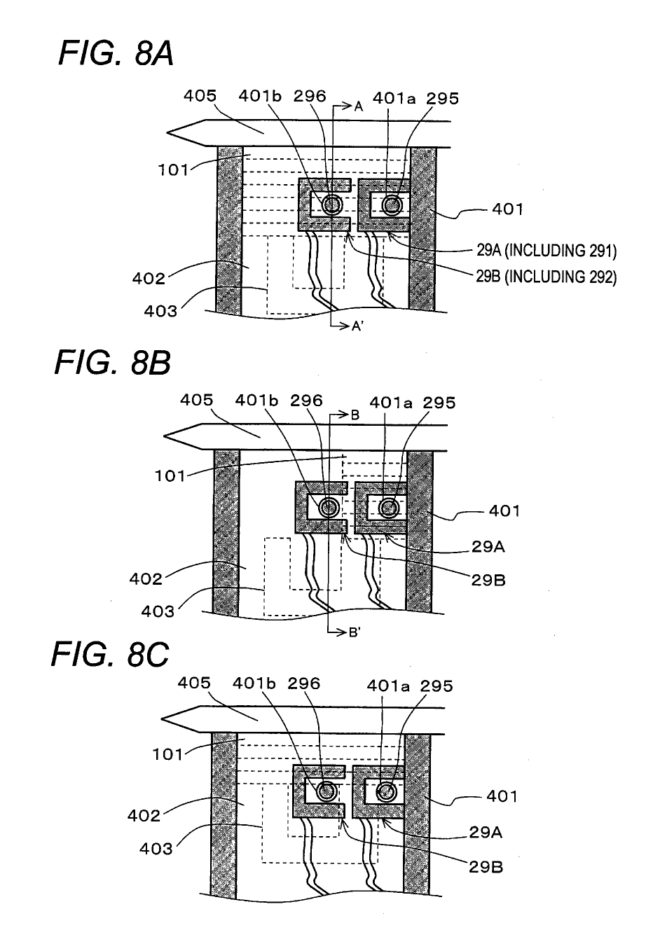

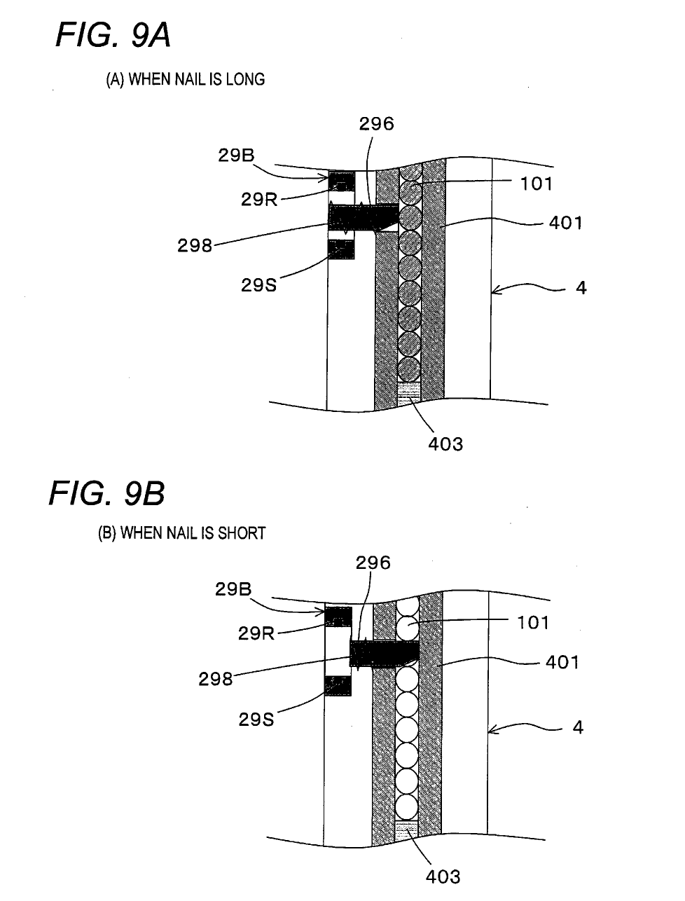

FIGS. 8A to 8C are schematic cross-sectional views for illustrating the length detecting unit in the electric tool 1 in which an interior of the magazine 4 is enlarged. FIG. 8A illustrates a case in which a long nail is located at a length detection position within the magazine 4, FIG. 8B illustrates a case in which a short nail is located at the length detection position, and FIG. 8C illustrates a case in which no nail is located at the length detection position (a case where the remaining amount of nails is short). FIG. 9A is a cross-sectional view taken along a line A-A′ in FIG. 8A. FIG. 9B is a cross-sectional view taken along a line B-B′ in FIG. 8B.

The magazine 4 holds a large number of nails 101 in a nail feed path 402 within a guide 401 in line, and pushes out the nails 101 upward (toward a driving preparatory position 405) by a pusher 403 that is urged upward by an urging unit such as a spring not shown. Photo interrupters 29A, 29B, nontransparent bar members 295, 296 as light blocking members, and a spring 298 (refer to FIGS. 9A and 9B) configure the length detecting unit of the nails.

As illustrated in FIGS. 9A and 9B, the photo interrupter 29B is fixed to an inner wall surface of the magazine 4, and includes a light emitting part 29S and a light receiving part 29R. The light receiving part 29R includes a nail detection switch 292 (refer to FIG. 1) formed of, for example, the photo interrupter 29A which turns on/off according to whether a light is received from the light emitting part 29S, or not. The photo interrupter 29A is of the same configuration as that of the photo interrupter 29B, and includes the nail detection switch 291 (refer to FIG. 1).

The bar member 296 is slidably supported by an opening 401a in a side surface of the guide 401, and a leading end of the bar member 296 can be projected toward the nail feed path 402. A position to which the bar member 296 is projected when viewed from a longitudinal direction of the nail 101 in the nail feed path 402 is defined as the length detection position. The spring 298 is configured by a tension spring, and has one end attached to a tail end of the bar member 296, and the other end attached to the side surface of the guide 401. The spring 298 urges the bar member 296 toward the nail feed path 402. The bar member 295 is of the same shape as that of the bar member 296, and is slidably supported by an opening 401b in the side surface of the guide 401. The bar member 295 is urged by a spring (not shown) in the same manner as that of the bar member 296.

The length detecting unit has the following three states.

1. When a long nail is located at the length detection position of the nail feed path 402, both of the bar members 295 and 296 are pushed to the external of the nail feed path 402 by long nails, and block optical beams from the light emitting parts of the photo interrupters 29A and 29B to the light receiving parts thereof. For that reason, both of the nail detection switches 291 and 292 turn off.

2. When a short nail is located at the length detection position of the nail feed path 402, the bar member 296 extends in the nail feed path 402 by the urging of the spring 298, and does not block the optical beam from the light emitting part 29S of the photo interrupter 29B to the light receiving part 29R. On the other hand, the bar member 295 is pushed to the external of the nail feed path 402 by the short nail against the urging of the spring, and blocks the optical beam from the light emitting part of the photo interrupter 29A to the light receiving part thereof. For that reason, the nail detection switch 292 turns on, and the nail detection switch 291 turns off.

3. When no nail is located at the length detection position of the nail feed path 402, both of the bar members 295 and 296 extend in the nail feed path 402 by the urging of the spring, and do not block the optical beams from the light emitting parts of the photo interrupters 29A and 29B to the light receiving parts thereof. For that reason, both of the nail detection switches 291 and 292 turn on.

Finally, the microcomputer 29 is connected to an LD terminal of the secondary battery 3. The LD terminal is a terminal for transmitting an overdischarge detection signal to the microcomputer 29 when a voltage of each cell configuring the secondary battery 3 becomes a given value or lower. That is, the secondary battery 3 is configured, for example, by four cells of lithium ion secondary batteries with 3.6 V of each cell connected in series, and internally includes a monitor IC that monitors a voltage of each cell. The monitor IC transmits the overdischarge detection signal from the LD terminal when a voltage of at least any cell becomes the given value or lower. Upon receiving the overdischarge detection signal, the microcomputer 29 turns off the FET 214, notifies an operator of overdischarge by display, voice, or other means, and turns off itself after a given time has been elapsed.

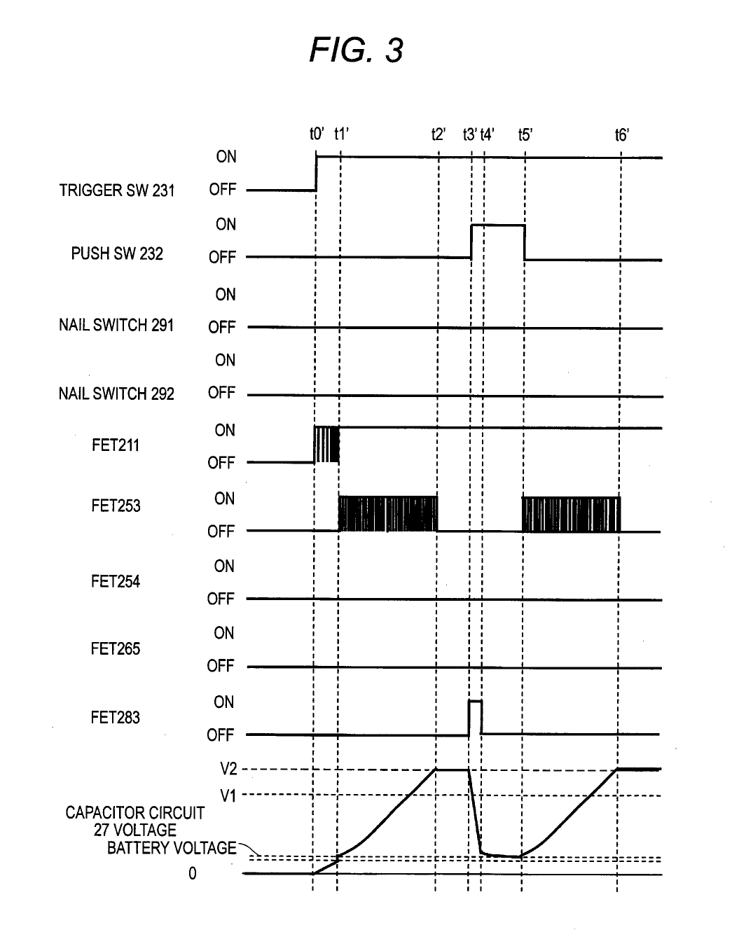

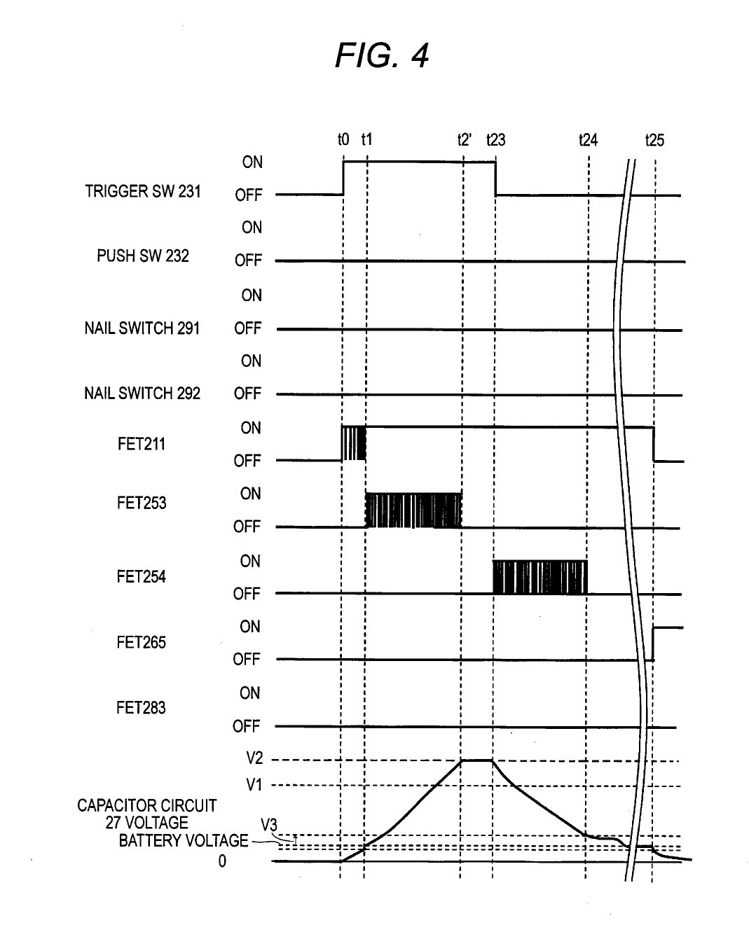

Hereinafter, the operation of the electric tool 1 will be described mainly with reference to FIGS. 1 to 5. FIG. 2 is a timing chart when the mails within the magazine 4 are short, FIG. 3 is a timing chart when the mails within the magazine 4 are long, and FIG. 4 is a timing chart when the nails within the magazine 4 are long, and a work stops after the pressure has been boosted.

In an initial state, a voltage across the capacitor circuit 27 is set to 0, and the respective switches (including the switching elements) are turned off.

The operation of the electric tool 1 starts by turning on any one of the trigger switch 231 and the push switch 232 through the operation of the operator (t0 in FIGS. 2 to 4). The operator appropriately determines whether to turn on the trigger switch 231 or the push switch 232 according to the work contents.

When any one of the trigger switch 231 and the push switch 232 turns on, a voltage is applied to the control power circuit 24 from the plus terminal of the secondary battery 3 through the turned-on switch and a diode (any one of the diodes 234 and 235) connected to that switch. The microcomputer 29 starts according to an output of the control power circuit 24.

(Initial Charging Process: t0 to t1 in FIGS. 2 to 4)

The microcomputer 29 turns on the FET 263 (S1 in FIG. 5), and reduces a potential at the gate terminal of the FET 265 to turn off the FET 265. As a result, the energization of the discharge resistor 264 stops.

The microcomputer 29 switches the FET 214 (S2 in FIG. 5). As a result, the FET 211 is switched in synchronism with the FET 211, and a voltage is applied to the control power circuit 24 through the diode 233. For that reason, even if the trigger switch 231 and the push switch 232 turn off, a start state of the microcomputer 29 can be maintained.

In this situation, the booster circuit 25 is inactive (boosting operation is not conducted), and the FET 253 is off. For that reason, the capacitor circuit 27 is charged from the secondary battery 3 through the inductance 252 of the booster circuit 25 and a parasitic diode of the FET 254. In this example, because the FET 211 is switched (intermittently turned on), a current is limited by the inductance 252, and no inrush current occurs into the capacitor circuit 27. Then, a flyback current of the inductance 252 is returned by the diode 251. As a result, the inrush current into the capacitor circuit 27 from the secondary battery 3 can be suppressed, and the costs can be made reasonable without extremely increasing rated values of the FET 211 and the FET 254.

The switching operation of the FET 211 by the microcomputer 29 is terminated when the voltage across the secondary battery 3 and the voltage across the capacitor circuit 27 become substantially equal to each other (S3 in FIG. 5). Thereafter, the microcomputer 29 turns on the FET 214, that is, the FET 211 to supply the electric power of the secondary battery 3 to the booster circuit 25 (S4 in FIG. 5). Immediately after that, the voltage across the capacitor circuit 27 substantially matches the voltage across the secondary battery 3 (t1 in FIG. 2 to FIG. 4). Thereafter, the processing is shifted to determination of whether there is a need to boost the voltage, or not. That is, the microcomputer 29 detects the on/off state of the trigger switch 231 and the push switch 232 (S5 and S6 in FIG. 5). This is conducted by allowing the microcomputer 29 to detect a voltage developed between both ends of the resistor 236 or 237 due to the on-operation of the above switches.

(Target Voltage Setting Process)

Then, when any one or both of the trigger switch 231 and the push switch 232 are on, the microcomputer 29 detects the states of the nail detection switches 291 and 292 (S7 and S8 in FIG. 5). First, the microcomputer 29 detects the state of the nail detection switch 291 (S7 in FIG. 5), and if the nail detection switch 291 is on, the microcomputer 29 determines that there is no nail (the remaining amount of nails is short), and sets a target boost voltage to the voltage across the secondary battery 3 (S9 in FIG. 5). That is, the voltage is not boosted by the booster circuit 25, and the voltage across the secondary battery 3 is applied to the capacitor circuit 27 as it is. When the nail detection switch 291 is off, the microcomputer 29 detects the output of the nail detection switch 292 (S8 in FIG. 5). Then, when the nail detection switch 292 is off, the microcomputer 29 determines that the nail is long, and sets the target boost voltage to V2 (S10 in FIG. 5). When the nail detection switch 292 is on, the microcomputer 29 determines that the nail is short, and sets the target boost voltage to V1 (S11 in FIG. 5). In this example, V1<V2 is satisfied. This is because the long tail requires a larger energy. With this configuration, since an appropriate energy can be set according to a length of the nail, an energy of the secondary battery 3 can be effectively used with energy saving, and a work rate per one charging operation can be improved. In an example of the target boost voltage, V1 is 100 V, and V2 is 150 V. The target boost voltage may be determined taking the weight of nails, a material, and other factors into account.

(Capacitor Charging Process: t1 to t2 in FIGS. 2, t1 to t2′ in FIGS. 3 and 4)

After the microcomputer 29 has set the target boost voltage to V1 or V2, the microcomputer 29 switches the FET 253 (S12 in FIG. 5), and allows the booster circuit 25 to execute the boosting operation. That is, when the FET 253 turns on, a current flows into the inductance 252 and the FET 253. Then, when the FET 253 turns off, the flyback current of the inductance 252 is charged in the capacitor circuit 27 through the parasitic diode of the FET 254, and the voltage across the capacitor circuit 27 is boosted toward the target voltage larger than the voltage across the secondary battery 3.

The voltage across the capacitor circuit 27 is detected by inputting a voltage divided by the resistors 267 and 268 to the microcomputer 29. Then, when the voltage across the capacitor circuit 27 reaches the target boost voltage (V1 or V2) set as described above, the microcomputer 29 stops the switching operation of the FET 253 (S13 and S14 in FIG. 5). During a period in which the capacitor circuit 27 is charged from the secondary battery 3, the terminal voltage of the secondary battery 3 is slightly reduced due to an influence of a voltage drop caused by an internal resistance (this reduction is not shown in the timing chart).

(Driving Process: t3 to t4 in FIG. 2, t3′ to t4′ in FIG. 3)

Then, the microcomputer 29 detects whether both of the trigger switch 231 and the push switch 232 are on, or not (S15 and S16 in FIG. 5). Only when both of those switches are on, the microcomputer 29 turns on the FET 283 (S17 in FIG. 15). Then, the electric charge accumulated in the capacitor circuit 27 is supplied to the plunger driving coil 281. As a result, the plunger 501 that forms a magnetic circuit of the plunger driving coil 281 is driven (the leading end blade part 501b is projected toward the driving preparatory position) to drive the nail. Then, after a given time (for example, 10 to 50 msec) has been elapsed, the microcomputer 29 turns off the FET 283 (S18 and S19 in FIG. 5), and a current that flows in the plunger driving coil 281 is returned to the diode 282, and consumed. With the above processing, one nail driving operation has been terminated.

Thereafter, the microcomputer 29 confirms that as least one of the trigger switch 231 and the push switch 232 is off (S20 and S21 in FIG. 5), and returns to determination of whether there is a need to boost the voltage, or not (S5 in FIG. 5). In this situation, the voltage across the capacitor circuit 27 is substantially equal to the voltage across the secondary battery 3. Thereafter, second and subsequent nail driving operation is implemented in the same flow as that of the first nail driving operation as the occasion demands (after t5 in FIG. 2, after t5′ in FIG. 3).

(Return Charging Process: t23 to t24 in FIG. 4)

Hereinafter, a description will be given of a return charging process of charging the secondary battery 3 from the capacitor circuit 27. A typical example of conducting this process is that after the voltage across the capacitor circuit 27 has reached the target boost voltage (V1 or V2) (after S14 in FIG. 5), the work stops without driving the nail (both of the trigger switch 231 and the push switch 232 turn off by the operation of the operator) (N in S15 and S22 of FIG. 5). In this case, the microcomputer 29 switches the FET 254 through the driver circuit 256 (S23 in FIG. 5). As a result, the voltage charged in the capacitor circuit 27 is charged in the secondary battery 3 through the FET 254, the inductance 252, and the parasitic diode of the FET 211. When the FET 254 turns off, the flyback current of the inductance 252 is returned through the parasitic diode of the FET 253. Since a current flows in the current detection resistor 255 when the FET 254 is switched, the microcomputer 29 detects the voltage across the current detection resistor 255, and can appropriately control the operation of charging the secondary battery 3 from the capacitor circuit 27.

The return charging process is executed until a difference between the voltage across the secondary battery 3 and the voltage across the capacitor circuit 27 becomes a given voltage value V3 or lower (S24 in FIG. 5). Thereafter, the microcomputer 29 turns off the FET 254 (S25 in FIG. 5), and results in a discharge standby state. Due to the operation of charging the secondary battery 3 from the capacitor circuit 27, the terminal voltage of the secondary battery 3 is slightly increased (recovered) as compared with that before the charging operation is executed (this increase is not shown in the timing chart).

(Discharging Process: from t25 in FIG. 4)

Hereinafter, a description will be given of the discharging process from a state where the voltage across the secondary battery 3 substantially matches the voltage across the capacitor circuit 27. For example, when the work has been terminated, both of the trigger switch 231 and the push switch 232 turn off through the operation of the operator (N in S5 and S6 of FIG. 5). Then, the microcomputer 29 comes to the discharge standby state, and turns off the FETS 214 and 263 after a given time (for example, 30 seconds) has been elapsed (S26 and S27 in FIG. 5). When the FET 214 turns off, the FET 211 turns off, and the secondary battery 3 is blocked to reduce the current consumption of the secondary battery 3. Further, when the FET 263 turns off, a voltage obtained by dividing the voltage across the capacitor circuit 27 by the resistors 261 and 262 is applied to the gate terminal of the FET 265, and therefore the FET 265 turns on. As a result, the electric charge in the capacitor circuit 27 is discharged through the discharge resistor 264 and the FET 265. Similarly, when the microcomputer 29 determines that there is no nail (the remaining amount of nails is short), the microcomputer 29 comes to the discharge standby state (from S9 to S26 in FIG. 5), and the discharging process is implemented likewise.

The above-mentioned discharging process (S27 in FIG. 5) is automatically implemented, for example, even when the secondary battery 3 is unexpectedly removed from the main body 2 of the electric tool 1. That is, when the secondary battery 3 is removed, the microcomputer 29 turns off, and the FETS 214 and 263 turn off. For that reason, even if the secondary battery 3 is unexpectedly removed, the electric charge accumulated in the capacitor circuit 27 can be rapidly discharged, and therefore the reliability is high.

This embodiment can obtain the following advantages.

(1) At least two kinds of target boost voltages (the target boost voltages of the capacitor circuit 27) can be set. The target boost voltage is set to V2 when the nail is long, and the target boost voltage is set to V1 when the nail is short (V1<V2). Therefore, unlike a case in which only one kind of target boost voltage is provided, no excessive charging operation is conducted for the short nail. That is, when the short nail is driven, if the capacitor circuit 27 is charged up to the same voltage as that of the long nail, a driving force larger than necessary is given (excessive supply of electric charge), and a battery energy becomes wasted. On the other hand, this embodiment can appropriately reduce such a waste. For that reason, the current (electric power) consumption of the circuit is reduced to improve the efficiency and save the energy with the result that the consumption of the battery can be suppressed.

(2) With the execution of the above-mentioned return charging process, even if the nail is driven although the voltage is boosted, the charging energy of the capacitor circuit 27 (a portion higher than the voltage across the secondary battery 3) can be recovered in the secondary battery 3 (the waste of the charging energy can be reduced). For that reason, as compared with a case in which the return charging process is not conducted, the current (electric power) consumption of the circuit is reduced to improve the efficiency and save the energy with the result that the consumption of the battery can be suppressed.

(3) In the above-mentioned initial charging process, the FET 211 is switched while the capacitor circuit 27 is charged from an initial voltage (for example, zero) to a voltage substantially equal to the voltage across the secondary battery 3. For that reason, a current is limited by the inductance 252 so that the inrush current can be prevented from flowing into the capacitor circuit 27. In the above-mentioned return charging process, because the FET 254 is switched, a current is limited by the inductance 252 so that an excessive current can be prevented from flowing into the secondary battery 3 from the capacitor circuit 27. Accordingly, as compared with a case in which the switching operation is not conducted, the rated values of the FET 211 and the FET 254 can be small, and downsizing and the cost reduction can be conducted. A reduction in the lifetime of the secondary battery 3 and the capacitor circuit 27 attributable to the excessive current (inrush current) can be suppressed.

(4) When the operator activates the trigger 503 (that is, when the trigger switch 231 turns on), the capacitor circuit 27 starts to be automatically charged toward the target boost voltage (V1 or V2). Therefore, when the operator thereafter pushes the leading end of the nose part 7 toward the material, because the capacitor circuit 27 has been completely charged or is being charged, a time since the operator operates the electric tool until the nail is driven can be shortened (response can be improved), and the operability can be improved. The same advantage can be obtained even in a case where the operator activates the trigger 503 after the leading end of the nose part 7 has been pushed toward the material.

(5) When the secondary battery 3 is removed, because the capacitor circuit 27 is automatically discharged, the reliability is high.

The present invention has been described above with reference to the embodiment. However, it would be understood by an ordinary skilled person that the respective constituent elements and the respective processes of the embodiment can be variously modified in the scopes of the claims. Hereinafter, modified examples will be described.

Three or more kinds of target boost voltages may be provided.

The secondary battery 3 may be a secondary battery other than the lithium ion secondary battery.

Each of the switching elements may be a noncontact switch (electronic switch) other than the FET.

Instead of or in addition to the parasitic diode between the drain and the source of each of the FETS 211, 253, and 254 as the current path, an additional diode may be connected in parallel between the drain and the source of each FET to form the current path.

The discharge standby time (S26 in FIG. 5) may be different between a case where both of the trigger switch 231 and the push switch 232 are off (N in S6 of FIG. 5) and a case where the remaining amount of fasteners is null (S9 in FIG. 5).

The standby time may be set to a time since both of the trigger switch 231 and the push switch 232 turn off after the voltage is boosted until the switching operation of the FET 254 starts (between S22 and S23 in FIG. 5). This is because the work may restart immediately after both of the trigger switch 231 and the push switch 232 turn off.

The optical length detection by the photo interrupter may be replaced with mechanical length detection in which two mechanical switches turn on/off according to whether the length of the fastener is a given length or longer, or not.

The present invention may be also applied to electric tool other than a nail driver, and especially may be applied to an electric tool whose driving source is supplied from a battery.

This application is based upon and claims the benefit of priority of Japanese Patent Applications No. 2011-042292 filed on Feb. 28, 2011 and No. 2011-042421 filed on Feb. 28, 2011, the contents of which are incorporated herein by reference in its entirety.

### REFERENCE SIGNS LIST

1 electric tool, 2 main body, 3 secondary battery, 21 power switch circuit, 22 battery voltage detector circuit, 23 switch detector circuit, 24 control power circuit, 25 booster circuit, 26a capacitor discharge circuit, 26b capacitor voltage detector circuit, 27 capacitor circuit, 29 microcomputer, 211, 214, 253, 254, 263, 265, 283 FET, 231 trigger switch, 232 push switch, 252 inductance, 281 plunger driving coil, and 291, 292 nail detection switch.

1. An electric tool comprising:
a secondary battery configured to supply an electric power;
a magazine configured to supply a fastener to a driving preparatory position;
a plunger that is projected toward the driving preparatory position so as to strike the fastener existing at the driving preparatory position;
a plunger urging unit configured to urge the plunger in a direction away from the driving preparatory position;
a plunger driving coil configured to generate a magnetic force for supplying a projection force to the plunger for projection to the driving preparatory position; and
a coil voltage generator configured to generate a supply voltage to the plunger driving coil, the coil voltage generator including a booster circuit that boosts a voltage of the electric power supplied from the secondary battery, a capacitor to which an output voltage of the booster circuit is applied, and which is disposed in parallel to the plunger driving coil, and a coil energization switch configured to switch on and off energization from the capacitor to the plunger driving coil,
wherein the secondary battery is configured to be charged by the capacitor having a terminal voltage higher than a terminal voltage of the secondary battery.

2. The electric tool according to claim 1 further comprising:
a current control switching element disposed between the capacitor and the secondary battery; and
a controller configured to control the current control switching element,
wherein if the capacitor has the terminal voltage higher than the terminal voltage of the secondary battery, the controller turns on the current control switching element to allow the secondary battery to be charged through the current control switching element from the capacitor.

3. The electric tool according to claim 1, wherein
the coil voltage generator includes a controller configured to control the booster circuit,
the booster circuit includes a booster inductance element, a booster switching element and the current control switching element,
the booster inductance element and the booster switching element is connected with each other in series between terminals of the secondary battery,
the capacitor is connected with the booster inductance in series and is connected in parallel to the booster switching element,
a diode parasitic in the current control switching element or disposed in parallel to the current control switching element allows a current to flow in a direction of charging the capacitor, and prevent the current from flowing in an opposite direction, the current flowing between a connection point of the booster inductance element and the booster switching element, and the capacitor, and
the controller is configured to boost the voltage of the electric power supplied from the secondary battery by switching the booster switching element in a state where the current control switching element is off, and is configured to charge the secondary battery through the current control switching element from the capacitor by turning on the current control switching element in a state where the booster switching element is off when the capacitor has the terminal voltage higher than the terminal voltage of the secondary battery.

4. The electric tool according to claim 2, wherein the controller charges the secondary battery after a given time elapses since the terminal voltage of the capacitor reaches a target boost voltage.

5. The electric tool according to claim 2, wherein the controller charges the secondary battery by switching the current control switching element.

6. The electric tool according to claim 2,
wherein the coil voltage generator includes a power switch circuit having a power switching element disposed between the secondary battery and the booster circuit, and
the controller makes the booster circuit inactive and switches the power switching element while the voltage across the capacitor is boosted from an initial voltage to a given voltage equal to or lower than the secondary battery.

7. The electric tool according to claim 2 further comprising a discharge circuit that is disposed in parallel to the capacitor on an output side of the booster circuit,
wherein the discharge circuit includes a discharge resistor and a discharge switching element which are connected in series between both terminals of the capacitor, first and second bias resistors which are connected in series between both the terminals of the capacitor, and a bias control switching element which is disposed in parallel to any one of the first and second bias resistors,
wherein a connection point of the first and second bias resistors is connected to a control terminal of the discharge switching element,
wherein the controller controls a voltage at the control terminal of the bias control switching element,
wherein the discharge switching element is turned off when the bias control switching element is turned on, and
wherein the discharge switching element is turned on when the bias control switching element is turned off.

8. The electric tool according to claim 7, wherein
the magazine, the plunger, the plunger urging unit, the plunger driving coil are provided in a main body,
the secondary battery is detachably attached to the main body, and
the bias control switching element turns off when the secondary battery is detached from the main body.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. A electric tool comprising;
a battery configured to supply an electric power; and
a main body including:
a driving unit;
a capacitor configured to accumulate electric charge supplied from the battery; and
a switch configured to switch on and off energization from the capacitor to the driving unit; and
a discharge circuit configured to discharge the electric charge of the capacitor,
wherein the battery is detachably attached to the main body, and
wherein the discharge circuit discharges the electric charge of the capacitor when the battery is detached from the main body.

28. The electric tool according to claim 27 further comprising a transforming circuit configured to boost a voltage of the electric power supplied from the secondary battery, the capacitor to which an output voltage of the transforming circuit is applied.

29. The electric tool according to claim 27, wherein the driving unit includes a coil for generating a magnetic force.

30. The electric tool according to claim 27, wherein
the discharge circuit includes discharge resistor and discharge switching element which are connected in series between both terminals of the capacitor, and
the electric charge of the capacitor is discharged via the discharge resistor and the discharge switching element.

31. The electric tool according to claim 30, wherein
the discharge circuit includes first and second bias resistors which are connected in series between both the terminals of the capacitor, and a bias control switching element which is disposed in parallel to any one of the first and second bias resistors,
a connection point of the first and second bias resistors is connected to a control terminal of the discharge switching element,
the discharge switching element is turned off when the bias control switching element is turned on, and
the discharge switching element is turned on when the bias control switching element is turned off.

32. The electric tool according to claim 31, wherein
the bias control switching element is turned on when the battery is attached to the main body, and
the bias control switching element is turned off when the battery is detached from the main body.

33. The electric tool according to claim 27, wherein
the battery is a secondary battery, and
the electric tool further comprises a switching element electrically connected between the secondary battery and the capacitor in series, and a controller configured to control the switching element,
the controller controls the switching element to charge the secondary battery if the controller detects that the switch is turned off.

34. The electric tool according to claim 28 further comprising a controller configured to control the transforming circuit to control charging voltage of the capacitor.

35. The electric tool according to claim 3, wherein the controller charges the secondary battery after a given time elapses since the terminal voltage of the capacitor reaches a target boost voltage.

36. The electric tool according to claim 3, wherein the controller charges the secondary battery by switching the current control switching element.

37. The electric tool according to claim 4, wherein the controller charges the secondary battery by switching the current control switching element.

38. The electric tool according to claim 3, wherein the coil voltage generator includes a power switch circuit having a power switching element disposed between the secondary battery and the booster circuit, and
the controller makes the booster circuit inactive and switches the power switching element while the voltage across the capacitor is boosted from an initial voltage to a given voltage equal to or lower than the secondary battery.

39. The electric tool according to claim 4, wherein the coil voltage generator includes a power switch circuit having a power switching element disposed between the secondary battery and the booster circuit, and
the controller makes the booster circuit inactive and switches the power switching element while the voltage across the capacitor is boosted from an initial voltage to a given voltage equal to or lower than the secondary battery.

40. The electric tool according to claim 5, wherein the coil voltage generator includes a power switch circuit having a power switching element disposed between the secondary battery and the booster circuit, and
the controller makes the booster circuit inactive and switches the power switching element while the voltage across the capacitor is boosted from an initial voltage to a given voltage equal to or lower than the secondary battery.

41. The electric tool according to claim 3 further comprising a discharge circuit that is disposed in parallel to the capacitor on an output side of the booster circuit,
wherein the discharge circuit includes a discharge resistor and a discharge switching element which are connected in series between both terminals of the capacitor, first and second bias resistors which are connected in series between both the terminals of the capacitor, and a bias control switching element which is disposed in parallel to any one of the first and second bias resistors,
wherein a connection point of the first and second bias resistors is connected to a control terminal of the discharge switching element,
wherein the controller controls a voltage at the control terminal of the bias control switching element,
wherein the discharge switching element is turned off when the bias control switching element is turned on, and
wherein the discharge switching element is turned on when the bias control switching element is turned off.

42. The electric tool according to claim 4 further comprising a discharge circuit that is disposed in parallel to the capacitor on an output side of the booster circuit,
wherein the discharge circuit includes a discharge resistor and a discharge switching element which are connected in series between both terminals of the capacitor, first and second bias resistors which are connected in series between both the terminals of the capacitor, and a bias control switching element which is disposed in parallel to any one of the first and second bias resistors,
wherein a connection point of the first and second bias resistors is connected to a control terminal of the discharge switching element,
wherein the controller controls a voltage at the control terminal of the bias control switching element,
wherein the discharge switching element is turned off when the bias control switching element is turned on, and
wherein the discharge switching element is turned on when the bias control switching element is turned off.

43. The electric tool according to claim 5 further comprising a discharge circuit that is disposed in parallel to the capacitor on an output side of the booster circuit,
wherein the discharge circuit includes a discharge resistor and a discharge switching element which are connected in series between both terminals of the capacitor, first and second bias resistors which are connected in series between both the terminals of the capacitor, and a bias control switching element which is disposed in parallel to any one of the first and second bias resistors,
wherein a connection point of the first and second bias resistors is connected to a control terminal of the discharge switching element,
wherein the controller controls a voltage at the control terminal of the bias control switching element,
wherein the discharge switching element is turned off when the bias control switching element is turned on, and
wherein the discharge switching element is turned on when the bias control switching element is turned off.

44. The electric tool according to claim 6 further comprising a discharge circuit that is disposed in parallel to the capacitor on an output side of the booster circuit,
wherein the discharge circuit includes a discharge resistor and a discharge switching element which are connected in series between both terminals of the capacitor, first and second bias resistors which are connected in series between both the terminals of the capacitor, and a bias control switching element which is disposed in parallel to any one of the first and second bias resistors,
wherein a connection point of the first and second bias resistors is connected to a control terminal of the discharge switching element,
wherein the controller controls a voltage at the control terminal of the bias control switching element,
wherein the discharge switching element is turned off when the bias control switching element is turned on, and
wherein the discharge switching element is turned on when the bias control switching element is turned off.
